(19) United States
(12) Patent Application Publication
(10) Pub. No.: US 2012/0233904 A1
(43) Pub. Date: Sep. 20, 2012

(54) FISHING LEADER STORAGE WALLET

(76) Inventor: Justin Dale Fox, Kettle Falls, WA (US)

(21) Appl. No.: 13/225,379

(22) Filed: Sep. 2, 2011

Related U.S. Application Data
(60) Provisional application No. 61/465,243, filed on Mar. 16, 2011.

(51) Int. Cl. A01K 97/06

(52) U.S. Cl. 43/4; 43/57.1

(57) ABSTRACT

Disclosed herein are examples of fishing leader storage wallets and devices. A fishing leader storage wallet may include a plurality of single-piece flaps for storing a fishing leader on an exposed surface of the single piece flaps.

### BACKGROUND

Due to the size and solid construction of a fishing tackle box, many fishermen have abandoned the idea of carrying tackle boxes on a boat or along the riverbank. Fishermen often use small plastic bags or cylinder shaped pieces of closed cell foam to transport fishing leaders; however, plastic bags are not durable and are difficult to keep organized, whereas foam pieces are bulky and cumbersome. There are many leader storage systems on the market; however, none have met the standard demanded by today's fishermen. Some are too large, some use less than sufficient materials, and others are much too costly.

Storage wallets for fishing leaders are known. For example, in U.S. Pat. No. 2,625,261 to Swift, a fisherman's fly book is disclosed wherein a series of staggered overlapping pockets with each containing an envelope with a possible fly therein. One pocket within the book can be used to hold a license card. The Lawless invention (U.S. Pat. No. 3,940,873) describes a shield for fish hooks wherein hook and loop pads within a hinged body engage the barbed hook end of an individual hook to shield it and restrain its movement. The fishing lure storage apparatus disclosed in the Pulver patent (U.S. Pat. No. 4,467,551) has a plurality of compartments that may be folded over on each other and maintained in that position by a releasable fastener. An external hook and loop means may be used to attach the folded compartments to a tackle box or other surface. The Young invention (U.S. Pat. No. 4,970,821) discloses a fishing tackle wrapper having envelopes in multiple rows with hook and loop closures for each envelope. A strip containing hooks or loops along the back of each envelope can be used to secure the folded envelopes together as a unit. In the Gentry et al. reference (U.S. Pat. No. 5,020,269) the fishing bait organizer describes a plurality of self sealing lure containing bags with loop fasteners used to attach the bags to a backing member. The present invention differs from these cited and the known prior art by providing for a foldable leader storage wallet wherein each fishing leader may be securely stored without pockets, hook and loop pads, or self sealing bags. Fishing leaders are stored securely using only the consistency of the material the fishing leader storage wallet is fashioned of

### SUMMARY

The present invention is a fishing leader storage wallet. According to one implementation, the wallet is comprised of a backing of waterproof material. A hem is formed around the entire border of the backing material, creating a smooth edge. Binding material is then sewn around the entire border of the backing material, covering both the hem and the smooth edge. A loop is formed with a length of web material and sewn along the border near the middle of the backing material, while in an open position. Hook and loop material, having two mating patches, is sewn on a first side, and the reverse side of the backing material to provide convenient opening and closing of the leader storage wallet. The hook and loop material is sewn along a large portion of the backing material to accommodate the added bulk of several leaders and components. 6 to 8 pieces of felt or felt like material are placed on the backing, where a vertical seam is sewn through the middle of the felt, permanently attaching it to the backing. Fishing leaders are then placed between pieces of felt. The leader storage wallet is then folded twice upon itself and secured with hook and loop mating patches. The objectives, features, and advantages of my invention will be more readily understood upon consideration of the following description of my leader storage wallet, taken in conjunction with the accompanying photographs.

### BRIEF DESCRIPTION OF THE DRAWINGS

FIG. 1. is a perspective view of a first side of an unfolded fishing leader storage wallet showing the flaps in which fishing leaders are placed for storage.

FIG. 2. is a perspective view of the reverse side of the fishing leader storage wallet of FIG. 1, showing hook and loop material.

FIG. 3. is a perspective view of a first side of an unfolded fishing leader storage wallet showing fishing leaders placed within flaps.

FIG. 4. is a perspective view of the reverse side of a folded fishing leader storage wallet in a folded position showing the vertical seam.

FIG. 5. is an edge view of the fishing leader storage wallet in a folded position.

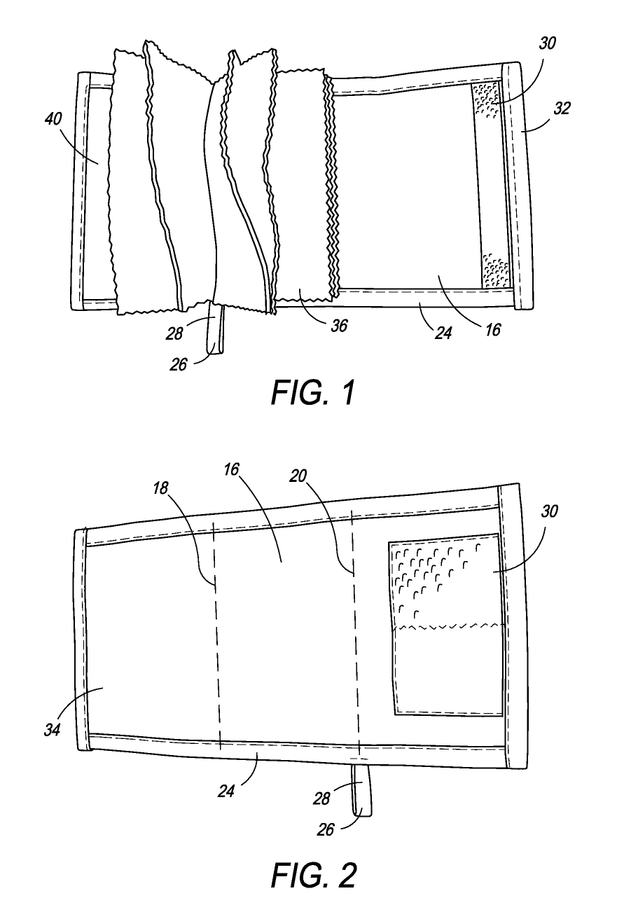

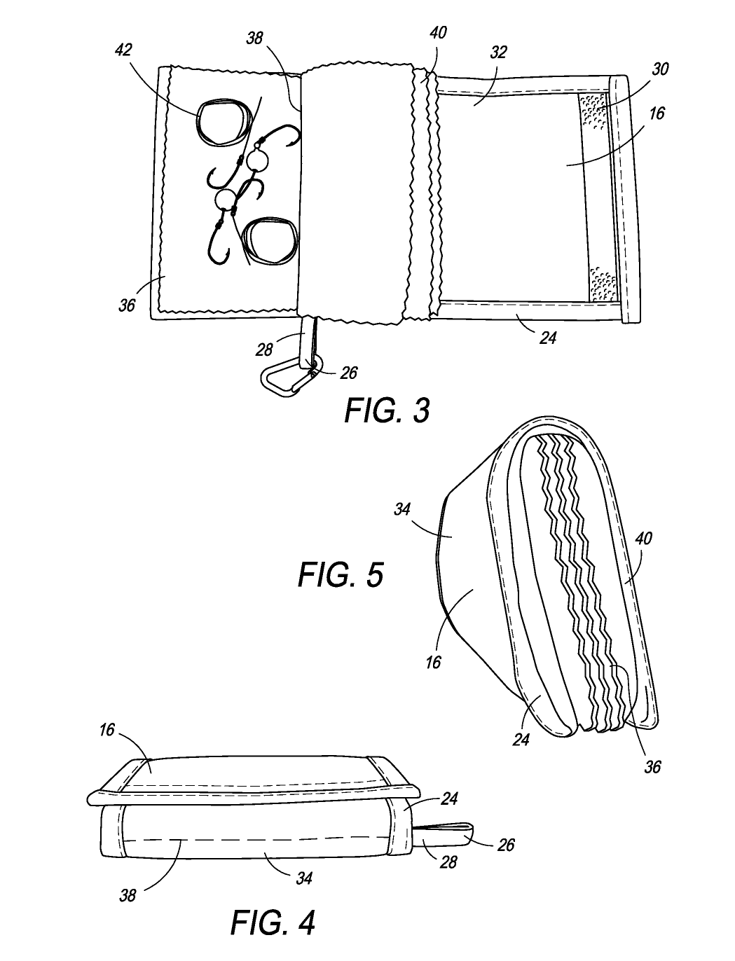

### DETAILED DESCRIPTION

Fishing leader storage wallet according to the present invention is comprised of flexible waterproof backing material 16 and has two folds 18 and 20 extending across its width. This permits the backing 16 to be folded twice upon itself to form a compact, tri-fold wallet like structure which can be conveniently carried by a user or stored in a garment pocket. A hem is formed around its entire border, creating a smooth edge. Binding material 24 is sewn around the entire border, covering the hem. Security loop 26 is sewn along border, near the middle of the embodiment using web like material 28. Mating patches of hook and loop material 30 are sewn on a first side 32, and reverse side 34 of the backing material 16. Finally, a soft, felt or felt like material 36 is sewn on the backing material 16 near the middle. A single, vertical seam 38 extending across its width holds the felt material 36 in place. When folded along folds 18 and 20 the felt material 36 creates flaps 40, much like pages in a book. Fishing leaders 42 are placed in between flaps 40 where they are stored. After leaders have been placed into the flaps of the fishing leader storage wallet, it is folded into a closed configuration as shown in FIG. 4 and ready for transport.

Experienced fishermen will quickly realize that the design described above has many advantages over current leader storage wallets. Unlike many other leader wallets, my fishing leader storage wallet is made of heavy duty, waterproof material. My fishing leader storage wallet has a dark colored background material on which fishing leaders are placed. This allows an easy visual inspection of various leaders withheld between flaps of the fishing leader storage wallet. The flaps are designed to maximize accessibility, and therefore, do not have pockets, snaps, buttons, hook and loop, or any other form of restriction. The felt material alone securely holds the fishing leaders in place. This design is superior to other fishing leader storage wallets in that it is a much simpler method. Each restriction (hook and loop, transparent plastic pocket, snap, button, etc.) placed upon the fisherman is one more item that must be manipulated in order to retrieve a fishing leader. Each additional item also has the potential to fail. With my fishing leader storage wallet, fishermen do not have to rely on fine motor skills, perhaps, with cold, stiff fingers, to retrieve a leader. Also, the sections of material are not affected by weather. Other leader wallets utilize transparent material to form small pockets in order to retain leaders. This material is not sturdy and is unable to maintain its strength in extremely cold or extremely hot weather. The material becomes very brittle in cold temperatures, and very limp in hot temperatures. It often cracks or rips when attempting to insert or remove a fishing leader. My fishing leader storage wallet also has an advantage in the way that it is secured. While many other leader wallets on the market use hook and loop closure, they fail to account for the added bulk of several leaders and components. This limits the carrying capacity of other leader wallets. Fishing leaders today often have more than one hook, several beads, many varieties of floatation aids, spinners, and other various components. My fishing leader storage wallet has a much larger closure flap and a much larger hook and loop area designed to account for the added bulk of several leaders and components. My fishing leader storage wallet also has a small loop, which allows a fisherman to secure the wallet to his fishing vest, pocket, or his boat by using one of many various fasteners available, including string, carabineer, bungee, etc. The added features, better design, and better quality materials are what set my fishing leader storage wallet apart from all other fishing leader storage wallets.

My fishing leader storage wallet folds into a compact size of approximately 4 inches by 6 inches. The small, compact design allows the fishing leader storage wallet to fit in a pants or shirt pocket. Moreover, the design lends itself to rapid construction by sewing together the various pieces. The flaps of felt which hold fishing leaders are formed by a single stitch. Different sizes and different materials can be used for all components. Cloth, leather, or nylon could be used as backing material. Any felt like material may be used as an alternative to true felt. In lieu of hook and loop closure, zippers, snaps, buttons, string and button, buckle, D-ring, or hook and eye could be used.

Although the present invention's preferred embodiment and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the scope of this invention.

I claim:

1. A fishing leader storage wallet comprising:
at least one flap for storing a fishing leader on an exposed surface of the at least one flap; and
a backing material configured to fold around the at least one flap.

2. The fishing leader storage wallet of claim 1, wherein the at least one flap allows a fishing hook to hook into the flap, the fishing hook attached to the fishing leader.

3. The fishing leader storage wallet of claim 1, wherein the flap comprises felt or a felt-like material.

4. The fishing leader storage wallet of claim 1, wherein the at least one flap consists of a single piece of material for storing a fishing leader on an exposed surface of the single piece of material.

5. The fishing leader storage wallet of claim 1, wherein the backing material is waterproof.

6. The fishing leader storage wallet of claim 1, wherein the backing material is configured to fold in a trifold configuration to at least partially enclose the at least one flap within the backing material.

7. The fishing leader storage wallet of claim 1, wherein the at least one flap comprises a plurality of flaps configured to store fishing leaders between adjacent flaps when the backing material is folded around the flaps.

8. The fishing leader storage wallet of claim 1, further comprising a loop extending from the fishing leader storage wallet.

9. The fishing leader storage wallet of claim 1, further comprising a soft material on a portion of the backing material that faces the at least one flap when the backing material is folded around the flaps.

10. The fishing leader storage wallet of claim 1, wherein the at least one flap is dark colored.

11. The fishing leader storage wallet of claim 1, wherein the at least one flap comprises a dark colored felt or a felt like material configured to allow a fishing hook to hook into the flap, the fishing hook attached to the fishing leader.

12. The fishing leader storage wallet of claim 1, wherein the wallet is approximately 4 inches by 6 inches when the backing material is folded.

13. The fishing leader storage wallet of claim 1, wherein the backing material is composed of at least one of cloth, leather, or nylon.

14. The fishing leader storage device of claim 1, wherein the at least one flap comprises a plurality of single piece felt flaps attached together at a folding centerline of the plurality of single piece felt flaps.

15. A fishing leader storage device comprising a plurality of single-piece flaps for storing a fishing leader on an exposed surface of the single piece flaps.

16. The fishing leader storage device of claim 15 further comprising a backing material configured to fold around the flaps to at least partially enclose the flaps.

17. The fishing leader storage device of claim 15, wherein the plurality of single piece flaps are attached together at a folding centerline of the plurality of single piece flaps.

18. A method of retrievably storing a fishing leader, the method comprising:
placing the fishing leader on a surface of a first flap; and
folding a second flap over the first flap to enclose the fishing leader between the first and second flap.

19. The method of claim 18, further comprising wrapping a backing material around the first and second flap to at least partially enclose the first and second flap with the backing material.

20. The method of claim 18, further comprising at least partially inserting a fishing hook into the first flap, the fishing hook attached to the fishing leader.
